(19) United States
(12) Patent Application Publication
(10) Pub. No.: US 2019/0252959 A1
(43) Pub. Date: Aug. 15, 2019

(54) ELECTRIC MACHINE

(71) Applicant: VOLABO GmbH, Ottobrunn (DE)

(72) Inventors: Adrian PATZAK, Munich (DE); Florian BACHHEIBL, Munich (DE)

(21) Appl. No.: 16/335,233

(22) PCT Filed: Sep. 19, 2017
(86) PCT No.: PCT/EP2017/073651

§ 371 Date: Mar. 20, 2019

(30) Foreign Application Priority Data
Sep. 22, 2016 (DE) 102016117911.6

(51) Int. Cl. H02K 16/02

(52) U.S. Cl. CPC H02K 16/02

(57) ABSTRACT

The invention relates to an electric machine (10), comprising a stator (11), which comprises at least two slots (12), in each of which an electrically conductive rod (13) is located, and at least two rotors (15, 27), which are movably mounted relative to the stator (11). The at least two electrically conductive rods (13) form an electrical winding (14) of the stator (11) and are configured to be supplied with an own electrical phase by a power supply unit (16), respectively. The at least two rotors (15, 27) comprise different numbers of pole pairs (p).

The present invention relates to an electric machine. The electric machine can comprise a stator and at least two rotors movably mounted relative thereto.

Electric machines can be operated as a motor or as a generator. The stator can comprise an electrical winding in slots, which is formed from an electrically conductive material, and, for example, has the shape of a rod. The electrical winding is connected to a power supply unit, which can be multiphase.

The electrical winding in the stator defines the shape of the rotating field, a magnetic field which is generated, during operation of the electric machine, by an energization of the electrical winding in the stator. The rotating field is temporally varying, so that a torque can be generated in the rotors. The rotating field can be decomposed into its harmonic components by means of a Fourier analysis. Here, the ordinal number of a harmonic component of the rotating field corresponds to a number of pole pairs of the stator. The number of pole pairs of the stator and of the rotor must be the same for synchronous rotors so that a torque is generated in the rotor during operation of the electric machine. In an asynchronous rotor, multiple harmonic components of the rotating field can generate a torque in the rotor.

If, in a vehicle with an electric machine, for example a left and a right wheel are to rotate at different rotating speeds and are to afford different forward feed motion, two separate electric machines with two converters are thus required. More space in the vehicle and more energy is thus required in order to generate different rotating speeds and torques of two wheels.

An object to be achieved lies in disclosing an electric machine which can be operated efficiently.

The object is achieved by the subject-matter of the independent claim. Advantageous configurations and developments are specified in the dependent claims.

According to at least one embodiment, the electric machine comprises a stator, which comprises at least two slots, in which at least one electrically conductive rod is located, respectively. The stator can comprise one or multiple stator sheets, in which the slots are formed. Preferably, the stator comprises a plurality of slots. The electrically conductive rods can be subdivided into sub-rods or comprise multiple rods, and can, for example, be formed with copper or aluminum. The electrically conductive rods can, on a first side of the stator, be electrically conductively connected with one another, for example via a short-circuit ring. The electrically conductive rods are thus connected with one another at one end such that they form a short-circuit.

According to at least one embodiment, the electric machine comprises at least two rotors movably mounted relative to the stator. The stator and the at least two rotors can be adjacent to an air gap. The rotors can be arranged in the stator or around the stator. A combination of rotors in the stator and around the stator is also possible. The at least two rotors can, for example, comprise a synchronous or asynchronous rotor or a combination of both.

According to at least one embodiment of the electric machine, the at least two electrically conductive rods form an electrical winding of the stator and are configured to be supplied with a respective own electrical phase by a power supply unit. The stator can thus be constructed in a manner similar to a squirrel cage rotor, wherein a short-circuit ring is only arranged on the first side of the stator. On the second side of the stator, the rods are connected to a power supply unit. The rods in the slots can thus be applied with an individual phase and an individual magnetomotive force per slot. Magnetomotive force, in this case, means that, for example, in each rod of the winding, currents with different frequencies and amplitudes can be superimposed. It is thus possible that the stator can simultaneously generate multiple different rotating fields. The different rotating fields can, for example, comprise different numbers of pole pairs. Furthermore, it is possible to change the rotating fields through a change of the energization of the rods during operation of the electric machine.

As the electrical winding, in the stator, is adapted to simultaneously generate multiple rotating fields with different numbers of pole pairs, the at least two rotors of the electric machine can be driven independently of one another. Only the one stator and a converter are required to that end. An independent actuation of at least two rotors in an electric machine with a stator can, for example, be advantageous in vehicles if two wheels rotate with different rotating speeds or are to produce different torques. This can, for example, be advantageous when cornering. Furthermore, the at least two rotors can be adapted for a different operation and can be actuated as needed. For example, one rotor can be adapted for fast driving and another rotor can be adapted for slow driving. In this case, no second stator and no second converter are needed, in order to drive at least two rotors of the electric machine. The electric machine can thus be operated more efficiently.

According to at least one embodiment of the electric machine, the at least two rotors comprise different numbers of pole pairs. The number of the poles in a rotor can, for example, be specified by the number of poles in the rotor generated by permanent magnets. The number of pole pairs in the rotor thus corresponds to half of the number of poles in the rotor. As the at least two rotors have different numbers of pole pairs, they interact with different rotating fields of the stator. That means, for each rotor, a respective own rotating field of the stator generates a torque in the respective rotor. For synchronous rotors, permanently or externally excited, and reluctance rotors, a torque is only generated in the rotor if the number of pole pairs of the stator and of the rotor match. For asynchronous rotors, for example squirrel cage rotors, it is also possible that a rotor interacts with multiple rotating fields of the stator.

According to at least one embodiment, the electric machine comprises a stator and at least two rotors movably mounted relative to the stator, wherein at least two electrically conductive rods, in slots in the stator, form an electric winding of the stator, and the rods are configured to be supplied with a respective own electrical phase from a power supply unit, respectively, and the at least two rotors have different numbers of pole pairs.

According to at least one embodiment of the electric machine, the stator is designed to generate at least two rotating fields with different numbers of pole pairs, wherein the at least two rotating fields are assigned, respectively, to one of the at least two rotors. The electric machine can further be designed to generate rotating fields with different frequencies, amplitudes and phase shifts. Due to the energization of the rods of the electrical winding, at least one rotating field is generated. By the separate supplying of the rods by the power supply unit, it is possible to generate further rotating fields, for example with a different rotating speed. That means multiple rotating fields of the stator can be superimposed. A rotating field is assigned to a rotor if the rotor interacts with the rotating field, this means, if a torque is generated in the rotor by the respective rotating field.

According to at least one embodiment of the electric machine, the stator is adapted to generate at least one rotating field for the at least two rotors, respectively, in that in at least one of the electrically conductive rods in the stator, at least two currents with different frequencies are superimposed. Superimposing currents with different frequencies can mean that a current with a first frequency for generating a first rotating field, and a current with a second frequency for generating a second rotating field are superimposed in a rod of the electrical winding. The first and the second rotating fields can comprise different numbers of pole pairs. The currents can be superimposed in one or in multiple rods of the electrical winding. An example of the superimposing of currents in the rods of the electrical winding is provided in the description of the Figures. In the superimposing of currents in the rods of the electrical winding, it is possible, that the amplitudes of the currents are dynamically adapted. Furthermore, it is possible that the different rotating fields are phase-shifted to one another.

To generate a rotating speed of a rotor, the rods of the electrical winding can respectively be energized in such a manner that the frequency f of the current is associated with the rotating speed n as follows:

n=f/p, (1)

wherein p is the number of pole pairs. In order to generate a rotating field, the currents in the rods are phase-shifted to one another, namely by

φ=2πp/m, (2)

wherein m represents the number of the phases with which the respective rotating field is generated.

According to at least one embodiment of the electric machine, at least one first electrically conductive rod of the electrical winding is adapted to exclusively generate a first rotating field, and at least one second electrically conductive rod of the electrical winding is adapted to exclusively generate a second rotating field. That means that the rods of the electrical winding can be supplied separately by the power supply unit. Preferably, a plurality of first electrically conductive rods of the electrical winding is adapted to exclusively generate a first rotating field, and a plurality of second electrically conductive rods of the electrical winding is adapted to exclusively generate a second rotating field. In the rods in which exclusively one rotating field is generated, no currents with different frequencies are thus superimposed. The rods of the electrical winding can thus be divided in order to generate the different rotating fields. It is also possible to generate more than two rotating fields. For example, the rods of the electrical winding can be alternatingly divided to generate two rotating fields. A different division of the rods is also possible, however.

According to at least one embodiment of the electric machine, a first number of electrically conductive rods of the electrical winding is adapted to generate a first rotating field, and a second number of electrically conductive rods of the electrical winding is adapted to generate a second rotating field. It is furthermore possible, with a different number of rods, to generate more than two rotating fields.

According to at least one embodiment of the electric machine, not each of the electrically conductive rods contributes to the generating of one or multiple rotating fields. It is thus possible that rods of the electrical winding are deactivated.

According to at least one embodiment of the electric machine, at least one rotor is adapted to interact only with one rotating field of the stator. That means that at least one rotor of the at least two rotors is a synchronous rotor. That means a torque is only generated in the synchronous rotor if the number of pole pairs of the rotor and of the stator match. That means the rotor and the stator only interact with each other in this case.

According to at least one embodiment of the electric machine, the at least two rotors are arranged on at least two coaxial shafts so that the at least two rotors can rotate independently of each other. In this case, coaxial means that the at least two rotors can rotate around a common axis. Here, the at least two shafts can, for example, be a solid and at least one hollow shaft. The torque can then be transmitted, for example via gear stages, similarly to double-clutch transmissions, onto drive axles, to the wheels of a vehicle. That means that the at least two rotors can rotate independently of one another if different rotating fields are set for the rotors, in the stator.

According to at least one embodiment of the electric machine, the at least two rotors are arranged torque proof on a shaft. That means that the at least two rotors can only rotate simultaneously, with the same rotating speed. This is advantageous, for example, in case the different rotors are designed to be operated efficiently for different situations. For example, a first rotor can be designed efficiently for a quick acceleration of a vehicle, and a second rotor efficiently for a slow and constant driving. Here, both rotors can be actuated simultaneously, or it is possible to select one of the rotors. For example, a synchronous and an asynchronous rotor can be arranged on the shaft.

According to at least one embodiment of the electric machine, at least one first rotor is an external rotor and/or at least one second rotor is an internal rotor. An external rotor is arranged around the stator, and an internal rotor is arranged in the stator. Combinations of internal and external rotors are furthermore possible.

According to at least one embodiment of the electric machine, the at least two rotors have different lengths along a connecting axis. It is thus possible to produce a stronger and a weaker partial drive. It is furthermore possible to combine different rotors with one another, which, for example, are designed for different operating modes, such as, for example, fast or slow driving and acceleration. Moreover, a shorter rotor can be used with a torque vectoring unit for a differential gear. Here, different torques are exerted on two wheels of a vehicle, for example. The shorter rotor, in this case, does not act directly upon a wheel of the vehicle, but rather on the differential, in order to contribute to the generating of the different torques.

According to at least one embodiment, the electric machine comprises at least one, or a combination of the following rotors:
an asynchronous rotor,
a rotor with permanent magnets,
an externally-excited synchronous rotor,
a rotor for a switched reluctance machine,
a rotor for a synchronous reluctance motor.

It is thus also possible that the electric machine comprises a combination of several of the mentioned rotors.

The electric machine can, for example, comprise two squirrel cage rotors, that is asynchronous rotors, which interact with the same first number of pole pairs of the stator. Here, it is possible that the electrically conductive rods comprise a different cant, for both squirrel cage rotors, respectively, in the slots of the squirrel cage rotors. It is thus possible that a first squirrel cage rotor additionally interacts with a second number of pole pairs of the stator, and a second squirrel cage rotor additionally interacts with a third number of pole pairs of the stator. The rotating field of the stator can be set such that the rotating speed of the rotating field is over-synchronous with the second number of pole pairs, and the rotating speed of the rotating field is sub-synchronous with the third number of the pole pairs. Consequently, the torque on the first squirrel cage rotor is increased, and the torque on the second squirrel cage rotor is weakened, so that the electric machine can be used as a differential gearing.

The electric machine described here is further explained in conjunction with exemplary embodiments and the associated figures below.

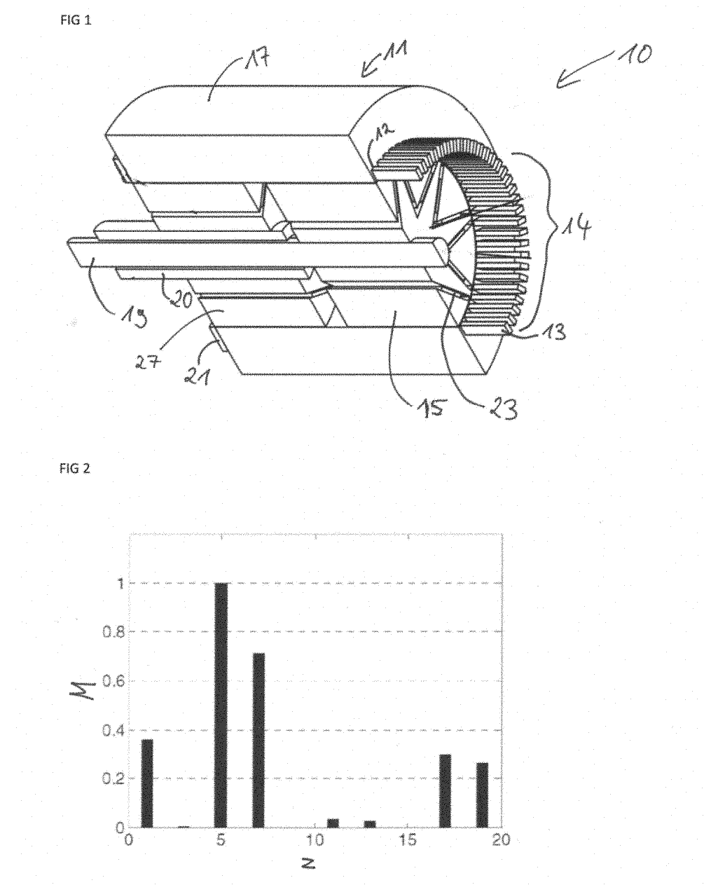

FIG. 1 shows a sectional view of an exemplary embodiment of an electric machine with a stator and two rotors.

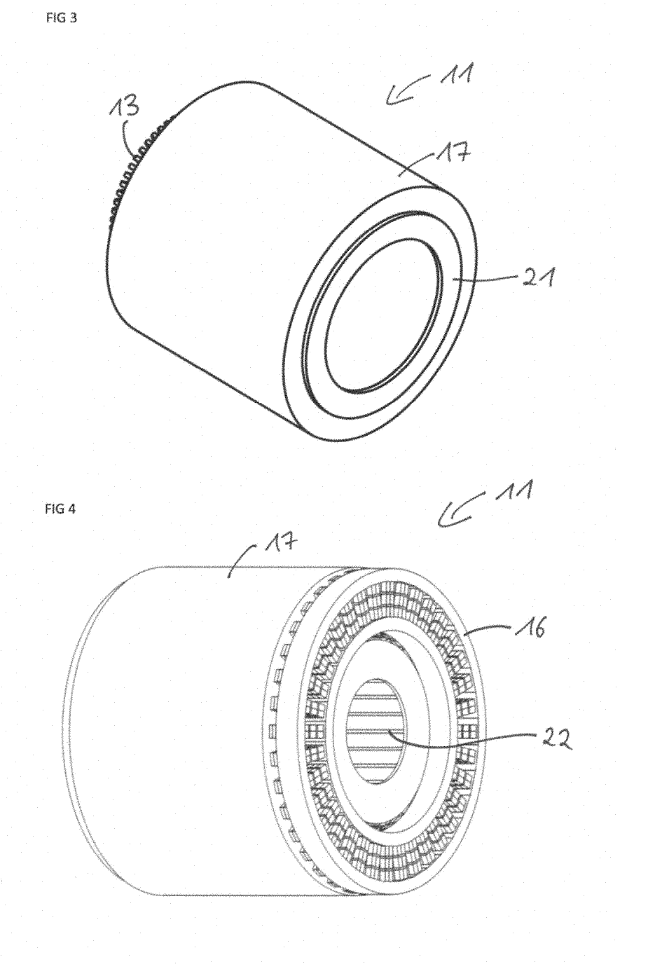

FIG. 2 shows an exemplary spectrum of a magnetic field of a stator with 12 slots.

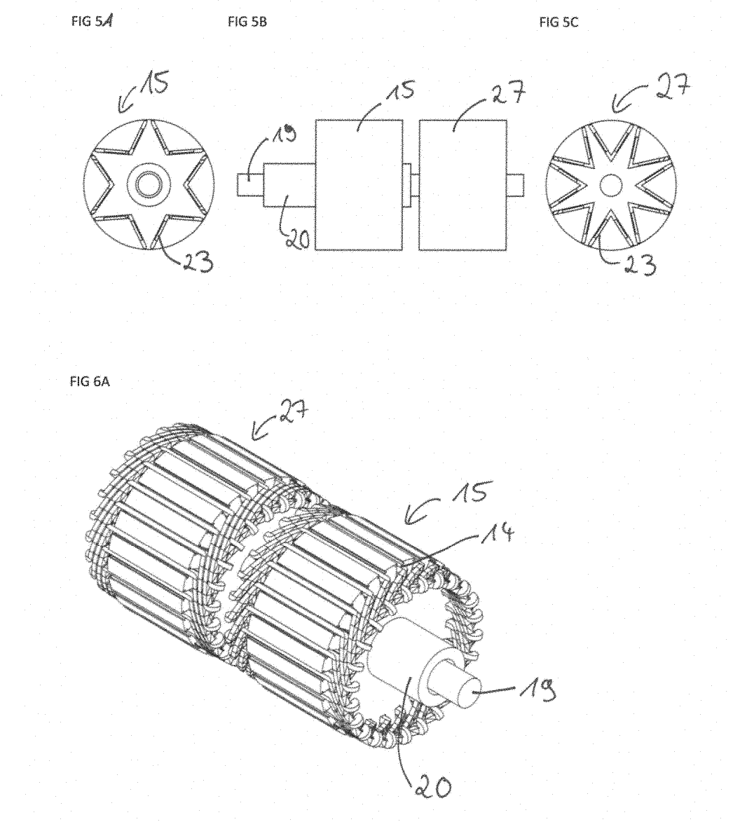

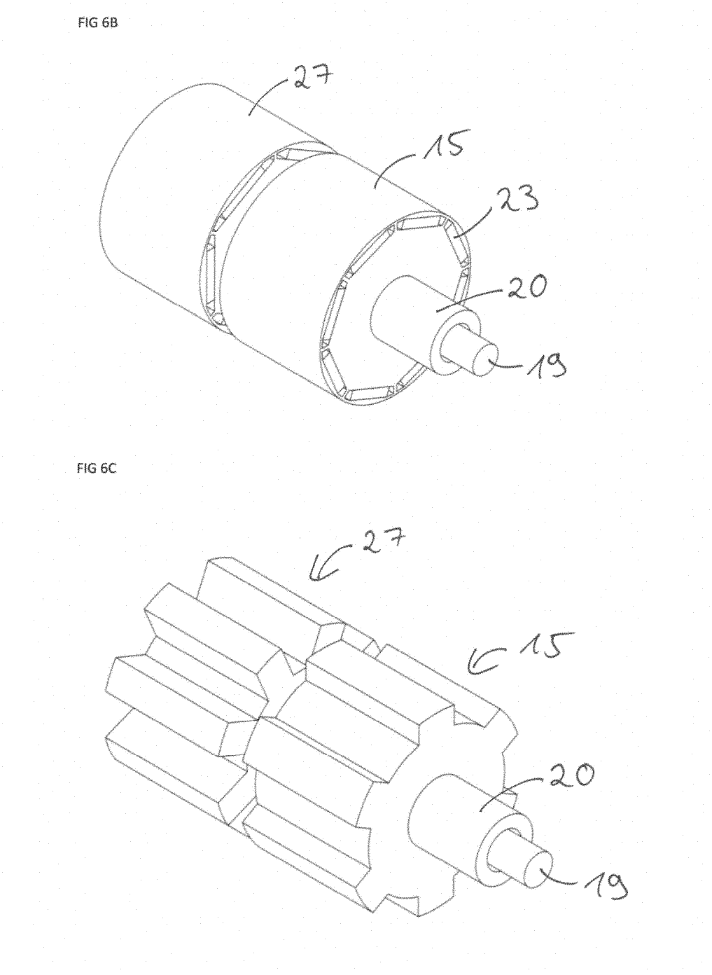

FIGS. 3 and 4 show exemplary embodiments of a stator.

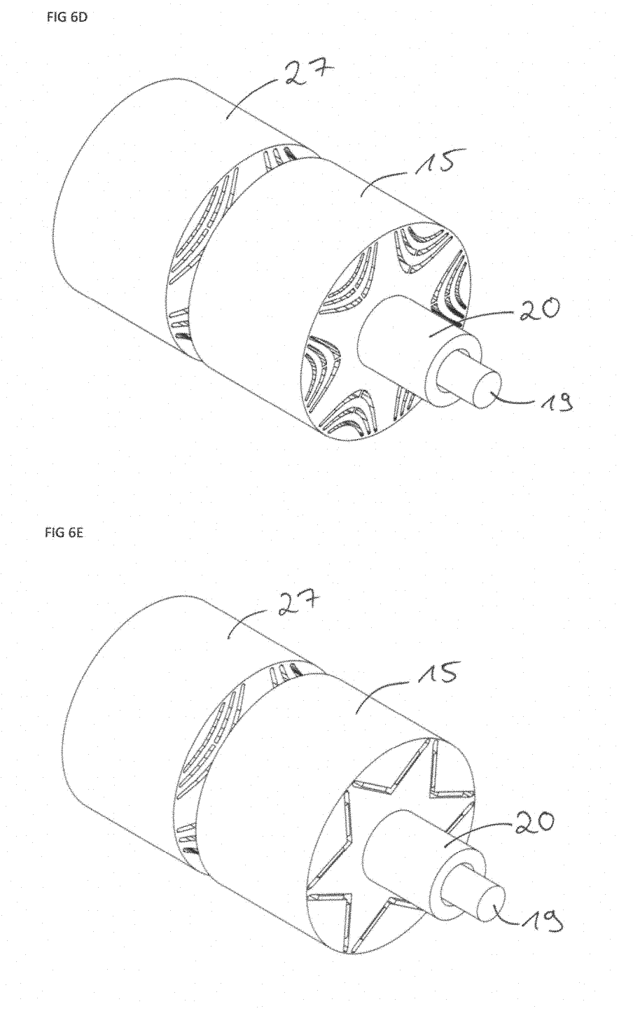

The FIGS. 5A to 5C show different views of an exemplary embodiment of two rotors.

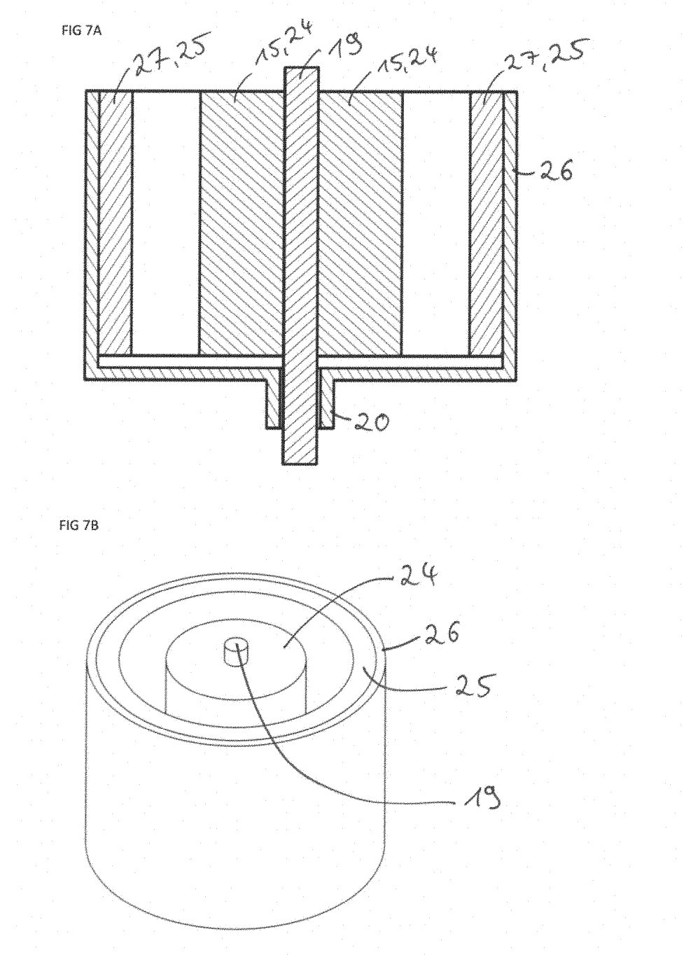

The FIGS. 6A to 6E show different exemplary embodiments of two rotors that are arranged on two shafts.

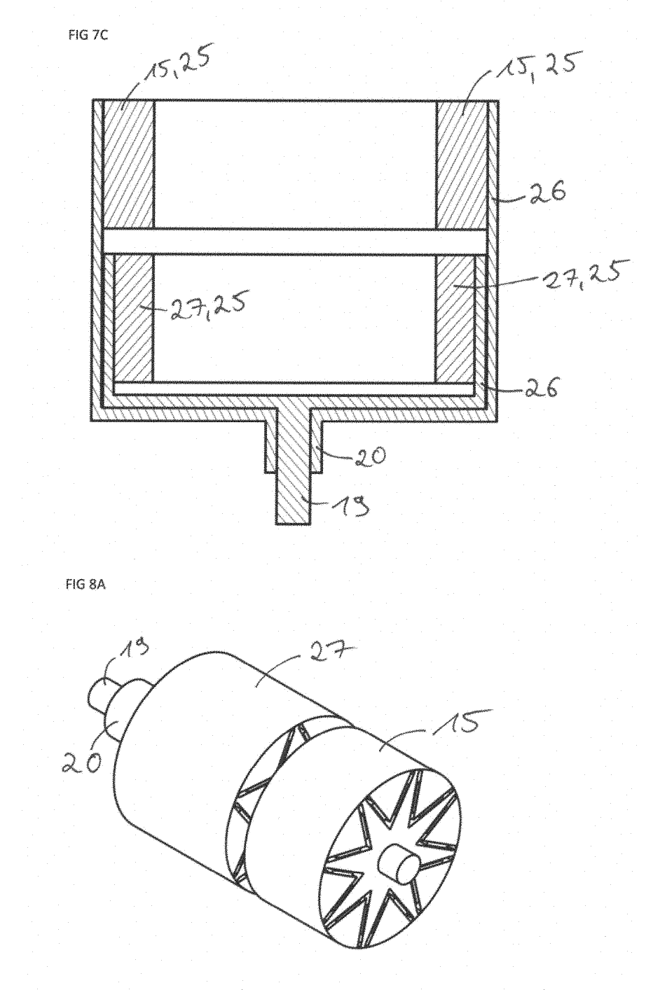

The FIGS. 7A to 7C show exemplary embodiments of rotors which are arranged as internal and as external rotors.

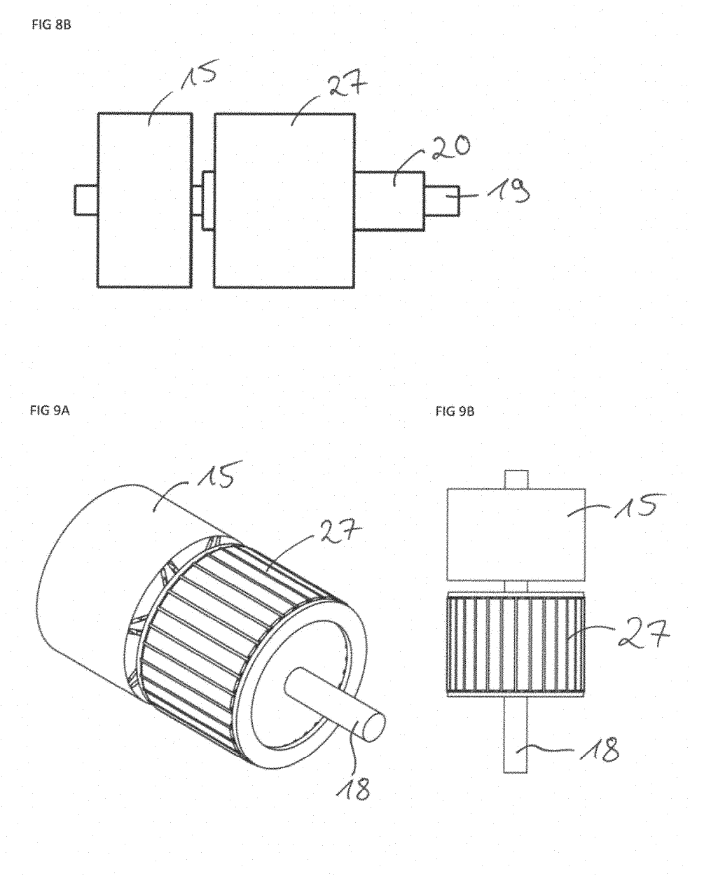

The FIGS. 8A and 8B show an exemplary embodiment of two rotors, which have different lengths.

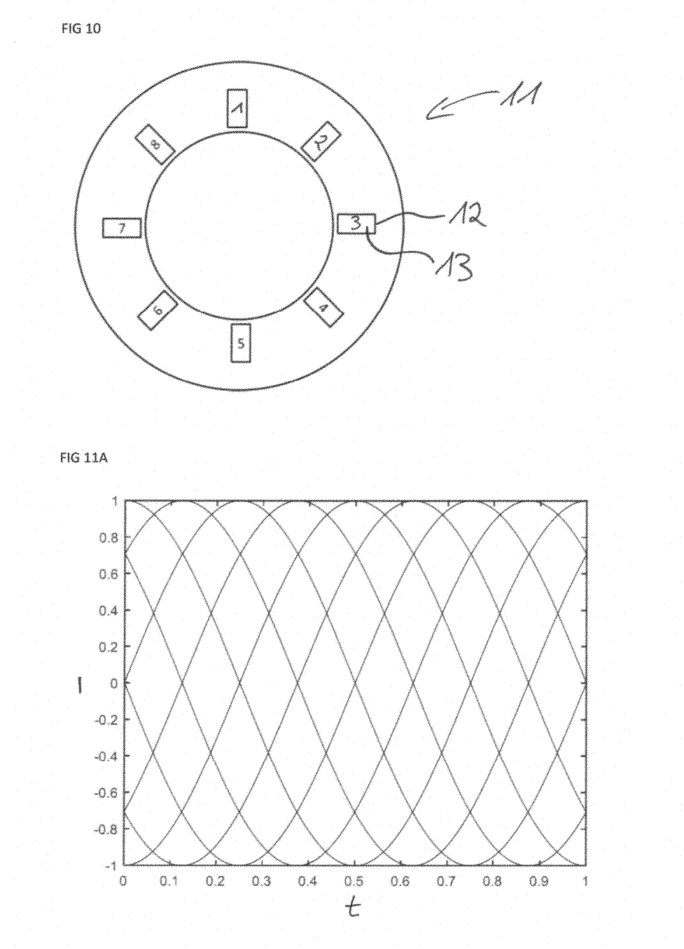

The FIGS. 9A and 9B show an exemplary embodiment of two rotors which are arranged on a shaft.

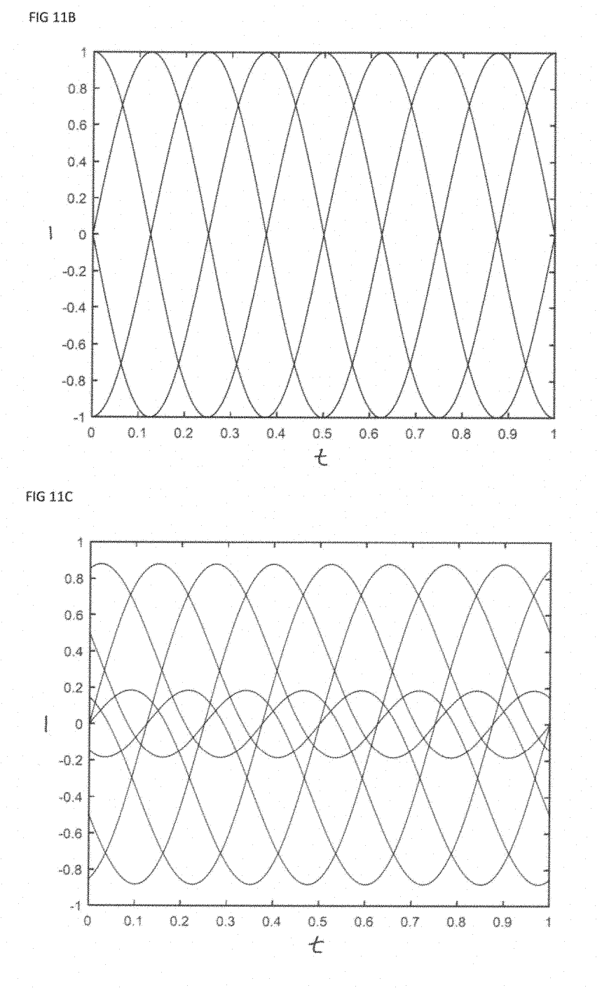

FIG. 10 shows a schematic cross-section through a stator with eight slots.

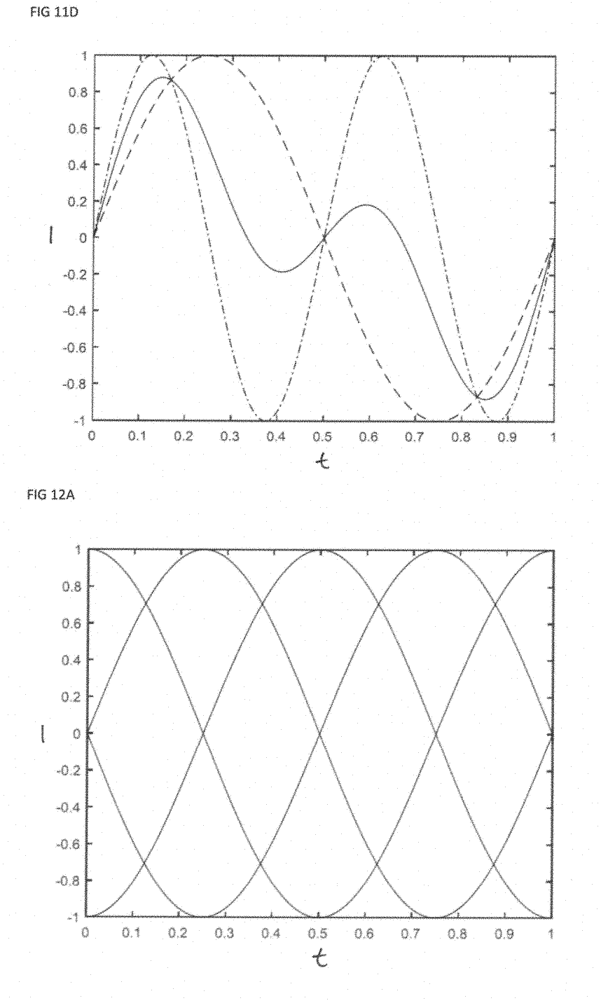

FIGS. 11A to 11D show exemplary curves of the current portions in the rods of the electrical winding.

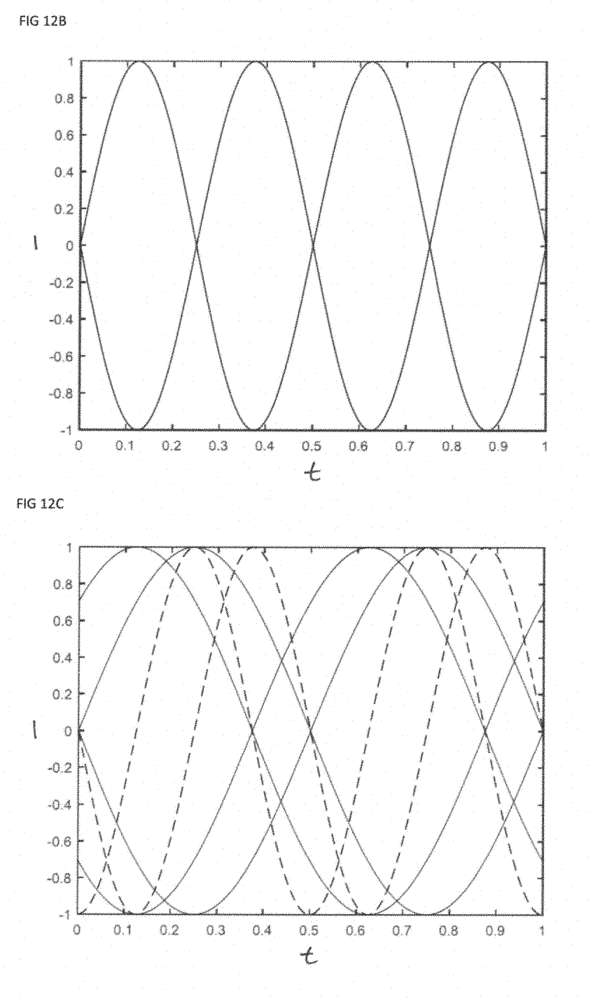

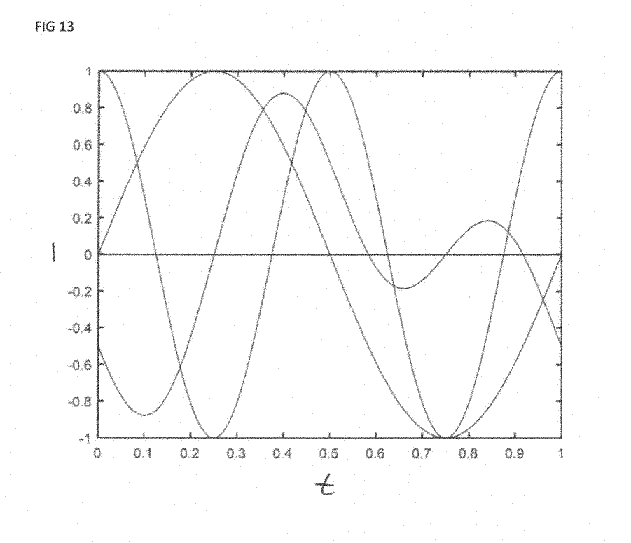

FIGS. 12A to 12C and 13 show further exemplary current power supplies in the rods of the electric winding.

FIG. 1 shows a sectional view of an exemplary embodiment of an electric machine 10 with a stator 11 and two rotors 15. The stator 11 comprises a laminated stator core 17, in which slots 12 are formed. An electrical winding 14 of the stator 11 is located in the slots 12 of the stator 11. To that end, an electrically conductive rod 13 is arranged in each slot 12 of the stator 11. The electrically conductive rods 13 thus form the electric winding 14 of the stator 11 and are configured to be supplied with a respective own electrical phase by a power supply unit 16. Two rotors 15 are arranged in the stator 11, which are movably mounted relative to the stator 11. Both rotors 15 are formed with buried permanent magnets 23. The rotors 15 are arranged coaxially on two shafts 18. Here, a first rotor 15 is arranged on a solid shaft 19, and a second rotor 27 is arranged on a hollow shaft 20. The torque of both rotors 15, 27 can then, for example, be transmitted, via gear stages, similar to in the double-clutch transmission, to the wheels of a vehicle. The two rotors 15, 27 comprise different numbers of pole pairs p. The rods 13 in the stator 11 are connected together electrically, on a first side of the stator 11, with a short-circuit ring 21. In further exemplary embodiments, it is possible that the electric machine 10 comprises further rotors 15, which are located on further hollow shafts 20.

FIG. 2 shows an exemplary spectrum of a magnetic field of a stator 11 with 12 slots during operation of the stator 11. The shape of the magnetic field generated by the stator 11 depends on the electric winding 14 in the stator 11. The magnetic field can be decomposed into its harmonic components by means of a Fourier analysis and represented in a spectrum. In FIG. 2, the magnetomotive force M is plotted, with different ordinal numbers z, for different harmonic components of the magnetic field. The associated stator 11 comprises a winding topology with 12 slots. The magnetomotive force M is, in FIG. 2, normalized to the magnetomotive force M of the harmonic component with the ordinal number z=5. Rotors 15, with the number of pole pairs p five or seven, can, with a stator 11, which has the represented spectrum, thus be operated the most efficiently. All further components in the spectrum which are not used to form a torque generate additional losses. Therefore, a rotor 15 with five pole pairs can, in this case, be operated the most efficiently.

It is furthermore possible, with this stator 11, to drive two rotors 15, 27 with different numbers of pole pairs p, namely five and seven. Advantageously, the rotors 15 are synchronous rotors, permanently or externally excited, which respectively only interact with one number of pole pairs p of the stator 11. The two rotors 15, 27 can be adapted as internal or external rotors 24, 25. The two rotors 15, 27 can thus rotate at different rotating speeds n, depending on selected current frequency f. The rotating speed n is specified by the current frequency f and the number of pole pairs p of the respective rotor 15:

n=f/p. (1)

However, it is not possible to change the number of pole pairs p of the stator 11 without changing the electric winding 14.

FIG. 3 shows an exemplary embodiment of a stator 11. The stator 11 comprises a laminated stator core 17, in which slots 12 are formed. An electrically conductive rod 13 is located in each slot 12. The rods 13 are electrically connected with each other, on a first side of the stator 11, with a short circuit ring 21. The rods 13 are free of a short circuit ring 21 on a second side of the stator 11.

FIG. 4 shows an exemplary embodiment of a stator 11, which is connected to a power supply unit 16. The rods 13 in the slots 12 can be supplied separately by the power supply unit 16. In this exemplary embodiment, the slots 12 are designed to be open towards the interior of the stator 11. Each slot 12 thus comprises an opening 22 towards the interior of the stator 11.

FIG. 5A shows a cross-section through an exemplary embodiment of a first rotor 15. The magnetic poles of the rotor 15 are formed by buried permanent magnets 23. The number of pole pairs p of this rotor 15 amounts to three.

FIG. 5B schematically shows the arrangement of two rotor 15, 27 on two shafts 18. A first rotor 15 is located on a hollow shaft 20 and a second rotor 27 is located on a solid shaft 19 so that both rotors 15, 27 can rotate independently of each other.

FIG. 5C shows a cross-section of an exemplary embodiment of the second rotor 27.

The magnetic poles are generated through permanent magnets 23 in the second rotor 27 as well. The number of pole pairs p of the second rotor 27 amounts to four.

FIG. 6A shows an exemplary embodiment of two rotors 15, 27, which are externally excited. The rotors 15, 27 are arranged on a solid shaft 19 and a hollow shaft 20. The rotors 15, 27 each comprise an electrical winding 14.

FIG. 6B shows a further exemplary embodiment of two rotors 15, 27. The two rotors 15, 27 are synchronous rotors with buried permanent magnets 23. Due to the different number of permanent magnets 23 in the rotors 15, 27, the rotors 15, 27 have different numbers of pole pars p.

FIG. 6C shows a further exemplary embodiment of two rotors 15, 27, which are rotors with different numbers of pole pairs p for a switched reluctance machine.

FIG. 6D shows a further exemplary embodiment of two rotors 15, 27, which are synchronous reluctance rotors. The two rotors 15, 27 have different numbers of pole pairs in this exemplary embodiment as well.

FIG. 6E shows a further exemplary embodiment of two rotors 15, 27. In this case, the first rotor 15 is a permanent magnet rotor and the second rotor 27 is a synchronous reluctance rotor. The number of pole pairs p of the permanent magnet rotor amounts to three, and the number of pole pairs p of the synchronous reluctance rotor amounts to two.

FIG. 7A schematically shows a cross-section through two rotors 15, 27. A first rotor 15 is adapted as an internal rotor 24 and is arranged on a solid shaft 19. A second rotor 27 is arranged around the stator 11 as an external rotor 25 via a holder 26. The stator 11 is not shown. The external rotor 25 is arranged on the hollow shaft 20 via the holder 26. The internal rotor 24 and the external rotor 25 can thus rotate independently of each other.

FIG. 7B shows the same arrangement as FIG. 7A. The internal rotor 24 is arranged on a solid shaft 19, and the external rotor 25 is arranged on a hollow shaft 20 via a holder 26. The stator 11 and the hollow shaft 20 are not shown.

FIG. 7C shows an exemplary embodiment of two rotors 15, 27, in which the rotors are both adapted as external rotors. The first rotor is arranged on the hollow shaft 20 via a first holder 26. The second rotor 27 is arranged on the solid shaft 19 via a further holder 26. The two rotors 15, 27 can thus rotate independently of each other. Here too, the stator 11 is not illustrated.

FIG. 8A shows a further exemplary embodiment of two rotors 15, 27. In this case, the two rotors 15, 27 have different lengths along the shafts 19, 20. Both rotors 15, 27 are permanent magnet rotors, however with different numbers of pole pairs p.

FIG. 8B illustrates the exemplary embodiment of FIG. 8A in plan view. The shorter rotor 15 is arranged on the solid shaft 19, and the longer rotor 27 is arranged on the solid shaft 20.

FIG. 9A shows an exemplary embodiment of two rotors 15, 27, in which two rotors 15, 27 of different lengths are arranged on a shaft 18. The first rotor 15 is a permanent magnet rotor, and the second rotor 27 is an asynchronous rotor. It is also possible to combine other synchronous rotors with the asynchronous rotor on a common shaft 18. Other synchronous rotors can, for example, be an externally-excited synchronous rotor, a rotor for a switched reluctance machine or a rotor for a synchronous reluctance motor. The asynchronous rotor can then be adapted, for example, for rotating fields with low numbers of pole pairs p, and the synchronous rotor can be adapted for a rotating field with a higher number of pole pairs p. It is furthermore possible to arrange two synchronous rotors on one shaft 18.

It is advantageous to arrange two rotors 15, 27 on one shaft 18 if, for example, the first rotor 15 is adapted to be efficient for a fast acceleration of a vehicle, and the second rotor 27 is adapted to be efficient for slow and constant driving. Here, both rotors 15, 27 can be simultaneously actuated, or it is possible to select one of the rotors 15, 27.

FIG. 9B shows a plan view of the exemplary embodiment of FIG. 9A.

FIG. 10 shows a cross-section through a stator 11 with eight slots 12. An electrically conductive rod 13 is located in each slot 12, which is supplied separately by the power supply unit 16. That is, each of the rods 13 can be supplied with a respectively own electrical phase, and it is furthermore possible to have currents I with different frequencies f superimposed in a rod 13. It is thus possible, with the rods 13, to set eight phases. The eight phases are numbered 1 to 8. The number of eight slots 12 is chosen merely as an example here. In other exemplary embodiments, other numbers of slots 12 are possible.

FIG. 11A plots exemplary curves of the current portions, in the eight rods 13 in the stator 11, which is shown in FIG. 10. The current I is normalized to one, and is plotted, over the time t, in seconds. The frequencies f can be determined for a specified rotating speed n with equation 1. That is, FIG. 11A illustrates the current portions of the eight phases, which generate a first rotating field. In this case, a rotating speed n of 1 Hz is set. The phase shifting y between adjacent phases is specified by equation 2. In this example, the first rotor 15 comprises two poles. Within one second, the first rotor 15 thus rotates once.

In FIG. 11B, exemplary curves of the current portions of the eight phases to generate a second rotating field are plotted. As the second rotor 27 comprises four poles, the frequency f for each pole is, in this case, doubled. Only four curves are shown in FIG. 11B, as the curves of two phases overlap, respectively.

FIG. 11C illustrates the superposition of the current portions of the eight phases for generating the first and the second rotating field. FIG. 11C thus shows the superposition of the current portions from the FIGS. 11A and 11B. Here, the amplitudes of the current portions were halved in order not to cause any too-high currents. The amplitudes can be dynamically adjusted depending on the required torque.

FIG. 11D shows the superposition of the current portions for generating the first and the second rotating fields only for one phase, that is for one rod 13. The amplitude of the superimposed signal is, in this case as well, adapted so that no currents which are too high occur. Furthermore, the current I for generating the first rotating field is represented dashed, and the current I for generating the second rotating field is represented as a dashed-dotted line. The superposition of both portions is represented as a solid line. In this case, there is no phase-shift between the two rotating fields. It is possible, however, that there is a phase shift between the two rotating fields.

FIG. 12A illustrates the current portions for four of the eight phases. In this case, the phases are divided up such that four of the eight phases generate the first rotating field, and the further four generate the second rotating field. According to the numbering in FIG. 10, the current portions of the phases 1, 3, 5, and 7 are represented in FIG. 12A. That is, only these four phases generate the first rotating field for the first rotor 15 with two poles. That is why the phase shift between the current portions is twice as high as in FIG. 11A.

In FIG. 12B, the current portions for the further four phases are represented. The phases 2, 4, 6, and 8 generate the second rotating field for the second rotor 27 with four poles. In further exemplary embodiments, it is possible that the phases are divided up differently. It is also possible that different numbers of phases contribute to the generation of the rotating fields, or that phases are divided up in any other desired manner.

Further examples for the dividing up of the phases for generating two different rotating fields are that the first rotating field is generated by the phases 1, 2, 3, and 4, and the second rotating field is generated by the phases 5, 6, 7, and 8, or that the first rotating field is generated by the phases 1, 2, 3, 4, and 5, and the second rotating field is generated by the phases 6, 7, 8.

FIG. 12C shows the current portions for generating two rotating fields. In this case, the first rotating field is generated by the phases 1, 2, 5, and 6, and the second rotating field is generated by the phases 3, 4, 7 and 8. The currents I for generating the first rotating field are represented as solid lines, and the currents I for generating the second rotating field are represented in a dashed manner.

FIG. 13 shows the current portions for generating two rotating fields. In this case, only three of the eight rods 13 are active, wherein phase 1 only contributes to generating the first rotating field, phase 2 only contributes to generating the second rotating field, and phase 7 contributes to generating both rotating fields, however with half the amplitude. In the current portion of phase 7, the portions for generating the first and the second rotating fields are superimposed. It is thus possible that each phase contributes to generating one or multiple rotating fields.

Generally, for each rod k, the individual current Ix, in the event of two rotating fields A, B, is specified by the following equation:

Iₖ=C_{k,A} sin(2πf_{A}+(k−1)(φ_{A})+C_{k,B} sin(2πf_{B}+(k−1)φ_{B}), (3)

with k=1 . . . m and m refers to the number of phases. The amplitudes of the respective current portions can be regulated via the pre-factors Cₖ. In the example in FIG. 13, the pre-factors amount to:

C_{A}=[1 0 0 0 0 0 0.5 0] and C_{B}=[0 1 0 0 0 0 0.5 0].

The current for each phase can also be specified for more than two rotating fields.

### LIST OF REFERENCE CHARACTERS

10: electric machine
11: stator
12: slot
13: rod
14: electric winding
15: rotor
16: power supply unit
17: laminated stator core
18: shaft
19: solid shaft
20: hollow shaft
21: short-circuit ring
22: opening
23: permanent magnet
24: internal rotor
25: external rotor
26: holder
27: second rotor
M: magnetomotive force
f: frequency
current
n: rotating speed
p: pole pair number
t: time
z: ordinal number

1. An electric machine, comprising:
a stator, which comprises at least two slots, in which one electrically conductive rod is located, respectively, and
at least two rotors movably mounted relative to the stator, wherein
the at least two electrically conductive rods form an electrical winding of the stator and are configured to be supplied with a respective own electrical phase by a power supply unit.

2. The electric machine according to claim 1, in which the at least two rotors can be controlled independently of each other.

3. The electric machine according to claim 1, in which the at least two rotors have different numbers of pole pairs.

4. The electric machine according to claim 1, in which the stator is adapted to generate at least two rotating fields with different numbers of pole pairs, wherein the at least two rotating fields are assigned, respectively, to one of the at least two rotors.

5. The electric machine according to claim 1, in which the stator is adapted to generate at least one rotating field for the at least two rotors, respectively, by superimposing at least two currents with different frequencies in at least one of the electrically conductive rods in the stator.

6. The electric machine according to claim 1, in which at least one first electrically conductive rod of the electric winding is adapted to exclusively generate a first rotating field, and at least one second electrically conductive rod of the electric winding is adapted to exclusively generate a second rotating field.

7. The electric machine according to claim 1, in which a first number of electrically conductive rods of the electrical winding is adapted to generate a first rotating field, and a second number of electrically conductive rods of the electrical winding is adapted to generate a second rotating field.

8. The electric machine according to claim 1, in which not every one of the electrically conductive rods contributes to generating one or multiple rotating fields.

9. The electric machine according to claim 1, in which at least one rotor is adapted to interact only with one rotating field of the stator.

10. The electric machine according to claim 1, in which the at least two rotors are arranged on at least two coaxial shafts, so that the at least two rotors can rotate independently of each other.

11. The electric machine according to claim 1, in which the at least two rotors are arranged co-rotationally on a shaft.

12. The electric machine according to claim 1, in which at least one first rotor is an external rotor and/or at least one second rotor is an internal rotor.

13. The electric machine according to claim 1, in which the at least two rotors have different lengths along a connecting axis.

14. The electric machine according to claim 1, which comprises at least one or a combination of the following rotors:
an asynchronous rotor,
a rotor with permanent magnets,
an externally-excited synchronous rotor,
a rotor for a switched reluctance motor,
a rotor for a synchronous reluctance motor.

15. Electric machine according to claim 1, in which the electrically conductive rods are electrically connected with each other via a short-circuit ring on a first side of the stator.
